(19) United States
(12) Patent Application Publication
(10) Pub. No.: US 2024/0012636 A1
(43) Pub. Date: Jan. 11, 2024

(54) GIT-BASED DELTA RPM

(71) Applicant: Red Hat, Inc., Raleigh, NC (US)

(72) Inventors: Pierre-Yves Chibon, Saint-Pol-de-Léon (FR); Leigh Griffin, Waterford (IE)

(21) Appl. No.: 17/858,947

(22) Filed: Jul. 6, 2022

(51) Int. Cl. G06F 8/71; G06F 8/73; H04L 67/1097

(52) U.S. Cl. CPC G06F 8/71; G06F 8/73; H04L 67/1097

(57) ABSTRACT

Embodiments of the present disclosure involve determining that a first subsequent version of a plurality of subsequent versions of a package is available, a repository is generated and a delta difference between a current version of the package and the first subsequent version of the package is committed to the repository. For each further subsequent version of the plurality of subsequent version of the package that is determined to be available, a delta difference between the further subsequent version of the package and an immediately preceding version of the package is generated and committed to the repository. In this way, a volume of discreet repositories that includes the delta difference history between each of the existing versions of the package is maintained and can be accessed to enable a client to build a subsequent (or previous) version of a package even if the current version they are running is multiple versions behind (or ahead).

### TECHNICAL FIELD

Aspects of the present disclosure relate to package management systems, and more particularly, to generation of delta-differences between consecutive versions of a package and storing the delta-differences using a Git repository.

### BACKGROUND

There are numerous contexts in which applications are often developed, tested, and delivered in containers using a container orchestration platform such as the Red Hat OpenShift™ platform. One example is the use of such platforms to automate and push software as containers to small-scale edge and Internet-of-Things (IoT) gateway devices in a domain. A domain may include of a group of devices that share the same configuration, policies, and identity stores. Containers may be created by stacking layers on top of each other to build an image file which may be used to create a container in which an application may run. Certain layers of an image file may correspond to various packages and libraries required to run the application, while other layers may correspond to various operating system packages via which applications are delivered and which are often shared among different applications. The packages and libraries used to run applications (referred to as an application ecosystem) may be managed by a package manager such as Dandified YUM (DNF) or the RPM package manager. Package management may refer to a method of installing, updating, removing, and keeping track of versions/software updates for packages in e.g., a Linux system. For example, the packager manager decides what packages should be grouped together and a basis on which they will update (e.g., packages in a particular group will not update except for necessary bug fixes and/or security fixes). Different Linux distributions may utilize different package managers.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram that illustrates an example system, in accordance with some embodiments of the present disclosure.

FIG. 1B is a block diagram that illustrates a detailed example system, in accordance with some embodiments of the present disclosure.

FIG. 2A is a block diagram that illustrates generation of delta differences and committing of the generated delta differences to a repository, in accordance with some embodiments of the present disclosure.

FIG. 2B is a block diagram that illustrates committing of generated delta differences to a repository and building of a new package version using the committed delta differences, in accordance with some embodiments of the present disclosure.

FIG. 3 is a block diagram that illustrates committing of generated delta differences to a repository and reverting to a previous package version using the committed delta differences, in accordance with some embodiments of the present disclosure.

FIG. 4 is a flow diagram of a method of building new versions of packages based on delta differences between prior versions of the package that have been committed to a repository generated to store delta difference between versions of the package, in accordance with some embodiments of the present disclosure.

FIG. 5 is a block diagram of an example computing device that may perform one or more of the operations described herein, in accordance with some embodiments of the present disclosure.

### DETAILED DESCRIPTION

Delta-difference generation is a mechanism by which a delta-difference between two packages (e.g., a current version of a package and a new version of the package) is generated. That delta-difference can then be downloaded by a package manager of a client, which is then able to reconstruct the new version of the package from the combination of the current version of the package and delta-difference. However, the delta-difference mechanisms generate a delta difference between a current version of a package and the version of the package that immediately follows the current version (e.g., version 1 of package A and version 2 of package A). When a subsequent version (e.g., version 3) is released, any delta difference between previous versions (e.g., versions 1 and 2) is deleted and a new delta difference between versions 2 and 3 is created. Thus, if the client has not updated to version 2 when version 3 is released, they must download the entire version 3 (i.e., they cannot combine version 1 with the generated delta differences). Only if the client has updated to version 2 at the time version 3 is released, can they combine the delta difference between versions 2 and 3 with version 2 of the package in order to generate version 3.

Currently, in order to be able to update from a particular version of a package to any other version (other than a version that immediately follows the particular version), a package manager must generate the delta difference between every different combination of existing versions. For example, if four versions of a package exist, and a user is currently running version 2 and wishes to update to version 4, the package manager must compute the delta difference between each different combination of the four package versions. This can result in increased resource consumption and time required to update the package.

In addition, current delta-difference mechanisms operate by tracking changes made by a subsequent version of the package and building the subsequent version of the package using those tracked changes, and are unable to remove/subtract changes made by the subsequent version (so as to revert to a previous version of the package).

The present disclosure addresses the above-noted and other deficiencies by using a processing device to generate a repository (e.g., a Git repository) in which a delta difference generated between a new version of a package and a version of the package immediately preceding the new version can be committed each time a new version is released. In this way, a volume of discreet repositories that includes the delta difference history between each of the existing versions of the package is maintained and can be accessed to enable a client to build a subsequent (or previous) version of a package even if the current version (i.e., the version of the package the client is currently running) is multiple versions behind (or ahead). More specifically, in response to determining that a first subsequent version of a plurality of subsequent versions of a package is available, the processing device may generate a repository corresponding to the package and generate a delta difference between a current version of the package and the first subsequent version of the package. The processing device may then commit the delta difference between the current version of the package and the first subsequent version of the package to the repository. At this point, for each further subsequent version of the plurality of subsequent versions of the package that is determined to be available, the processing device may generate a delta difference between the further subsequent version of the package and an immediately preceding version of the package and commit the delta difference between the further subsequent version of the package and the immediately preceding version of the package to the repository.

In response to receiving a request to update the package to a particular subsequent version of the package, the processing device may retrieve from the repository, a delta difference corresponding to the particular subsequent version of the package and a delta difference corresponding to each subsequent version of the package before the particular subsequent version of the package. The processing device may then build the particular subsequent version of the package based on the current version of the package and each of the retrieved delta differences.

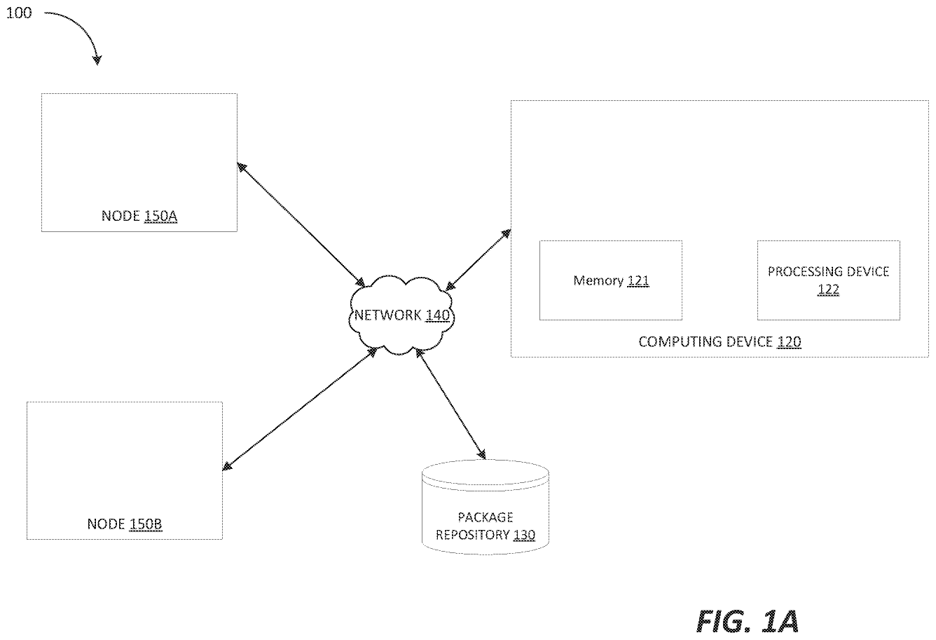

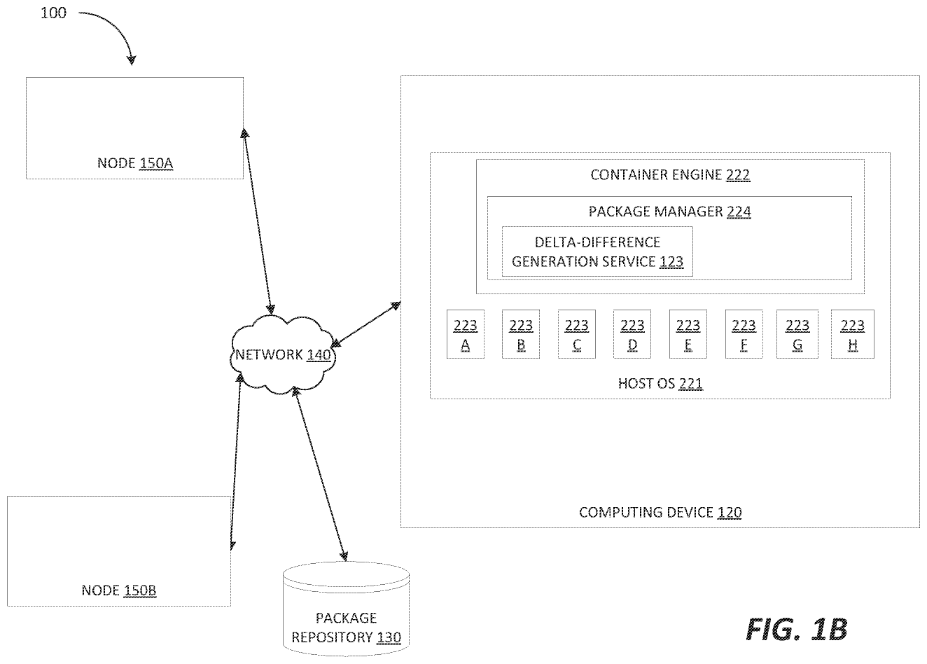

FIG. 1A is a block diagram that illustrates an example system 100. As illustrated in FIG. 1A, the system 100 includes a computing device 120, a package repository 130, nodes 150A and 150B, and a network 140. The computing device 120, nodes 150, and the package repository 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g. cell towers), etc. The network 140 may carry communications (e.g., data, message, packets, frames, etc.) between computing device 120, nodes 150, and the package repository 130. Each of the computing device 120, nodes 150, and the package repository 130 may include hardware such as processing device 122 (e.g., processors, central processing units (CPUs), memory 121 (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

FIG. 1A and the other figures may use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

Each of the computing device 120, nodes 150, and the package repository 130 may comprise any suitable type of computing device or machine that has a programmable processor including, for example, server computers, desktop computers, laptop computers, tablet computers, smartphones, set-top boxes, etc. In some examples, the computing device 120, nodes 150, and the package repository 130 may comprise a single machine or may include multiple interconnected machines (e.g., multiple servers configured in a cluster). The computing device 120, nodes 150, and the package repository 130 may be implemented by a common entity/organization or may be implemented by different entities/organizations. For example, computing device 120 may be operated by a first company/corporation and package repository 130 may be operated by a second company/corporation. The computing device 120, nodes 150, and the package repository 130 may each execute or include an operating system (OS), as discussed in more detail below. The OSs of computing device 120 (shown in FIG. 1B as host OS 221), nodes 150, and the package repository 130 may manage the execution of other components (e.g., software, applications, etc.) and/or may manage access to the hardware (e.g., processors, memory, storage devices etc.) of their respective computing device.

Referring to FIG. 1B, the computing device 120 (and any of the nodes 150) may include a container (not shown). In some embodiments, the container may execute on a container engine 222 which executes on top of the host OS 221 of computing device 120. The container engine 222 may allow different containers to share the host OS 221 (e.g., the OS kernel, packages 223, binaries, libraries thereof etc.) and may also perform other functions, as discussed in more detail below. The container 114 may be isolated, in that it is not connected to any other device or component of system 100, whether virtual or otherwise. The container may execute an application, which may be any application that requires certain packages 223 to facilitate its operation.

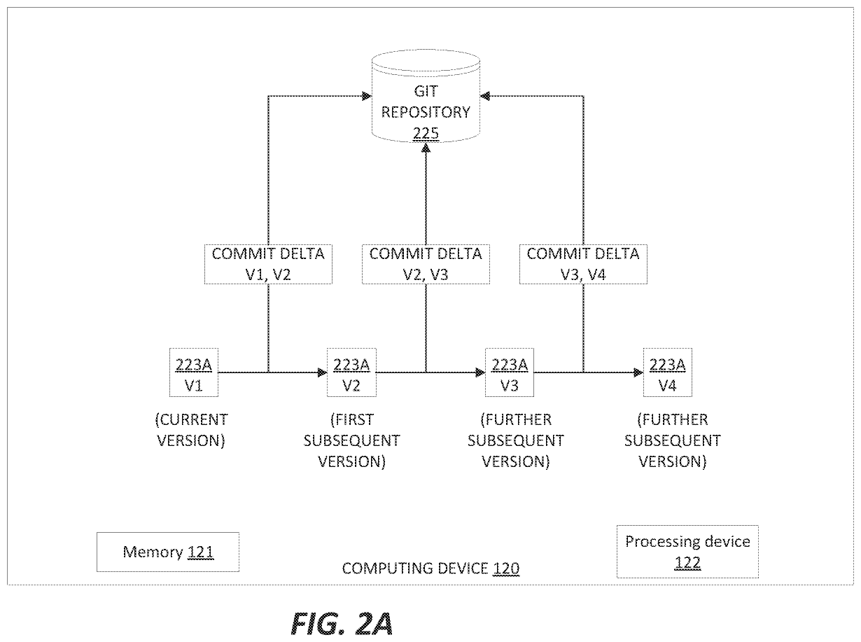

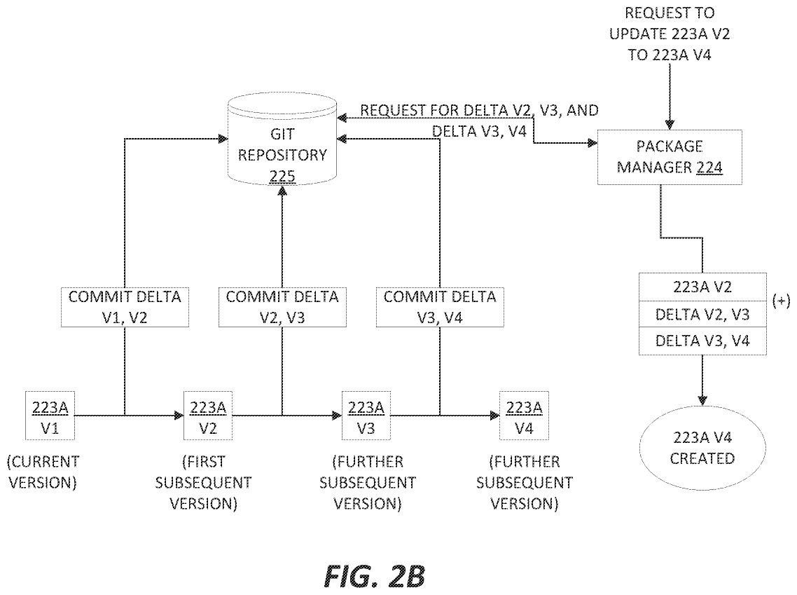

The container may share the OS kernel and packages 223 (e.g., libraries, binary files and source files) of the host OS 221 with other containers (not shown) that are executing on the computing device 120. The container engine 222 may allow different containers to share the host OS 221 (including e.g., the OS kernel as well as relevant packages 223 including any associated libraries, binary and/or source files etc.) of the computing device 120. For example, the container engine 222 may multiplex the packages 223 of the host OS 221 between multiple containers as discussed in further detail herein. The container engine 222 may also facilitate interactions between a container and the resources of the computing device 120 and may manage requests from the container to access certain packages 223 of the host OS 221. Although FIG. 2A shows the packages 223 as included within the host OS 221, in some embodiments the packages 223 may be stored separately (e.g., within package repository 130) and accessed by host OS 221 as necessary.

As discussed above, the host OS 221 of the computing device 120 may comprise a plurality of packages 223, each of which may be a program that provides certain functionality (e.g., for executing an application). The host OS 221 of the computing device 120 may also include a software package manager 224 that interfaces with repositories in the package repository 130 to search for packages, as well as install, update, and remove packages on the respective host OS. The package repository 130 may comprise multiple repositories that store packages corresponding to a core set of underlying OS functionality, user space applications, runtime languages, and databases in support of various types of workloads and use cases, among others. The software package manager 224 (hereinafter referred to as package manager 224) may be any appropriate package management software such as Dandified Yum, for example. The package manager 224 may automatically compute dependencies of a package 223 and determine any actions required to install a package. Each of the plurality of packages 223 may be in any appropriate format, such as e.g., the “.rpm” format. Stated differently, each package 223 may comprise an RPM file (e.g., based on Fedora, RHEL, etc.) or any other appropriate operating system packaging unit. The package manager 224 may install, update, and remove packages and their dependencies on their respective computing device. The package manager 224 may facilitate maintenance of packages 223 and their dependencies by automatically checking for further dependencies and determining the actions required to install those dependencies.

As shown in FIG. 1B, the package manager 224 may include a delta difference generation service 123 that may perform the delta-difference generation function for each package 223 in accordance with embodiments of the present disclosure, as discussed in further detail herein. More specifically, for each package 223, the delta difference generation service 123 may create a dedicated Git repository (shown in FIGS. 2A and 2B) in which the delta difference between different versions of the package 223 may be committed as discussed in further detail herein. Git is an application that tracks changes in any set of files, and upon initialization with a set of files corresponding to an application, may generate a new Git repository. The Git repository may be a folder that tracks all changes made to the application, and builds a history of such changes over time. Git may serve (via e.g., a backend program) the contents of the Git repository to Git clients that are accessing the repository over http:// and https:// protocols, or other suitable protocols. Although embodiments of the present disclosure are described with respect to a Git repository, any appropriate repository that tracks and commits changes between versions of an application/package may be used.

FIGS. 2A and 2B illustrate an example in which the delta difference generation service 123 creates a Git repository 225 for storing the delta difference between different versions of package 223A. Referring to FIGS. 2A and 2B, the host OS 221 may include a first version of package 223A (illustrated in FIGS. 2A and 2B as 223A V1) that is the current version of package 223A and the package manager 224 may continuously monitor for new versions (also sometimes referred to herein as subsequent versions) of package 223A. In response to detecting that a second version (also sometimes referred to herein as a first subsequent version) of package 223A (223A V2 in FIGS. 2A and 2B) has been released, the delta difference generation service 123 may create the Git repository 225, generate a delta difference between the first and second versions of package 223A (i.e., the delta difference between 223A V1 and 223A V2—also referred to as delta V1, V2), and commit the delta V1, V2 to the Git repository 225. Upon determining that a third version (which may be one of a number of further subsequent versions) of package 223A (223A V3) has been released, the delta difference generation service 123 may generate a delta difference between the second and third versions of package 223A (delta V2, V3), and commit the delta V2, V3 to the Git repository 225. Similarly, upon determining that a fourth version (which may be one of the number of further subsequent versions) of package 223A (223A V4 in FIGS. 2A and 2B) has been released, the delta difference generation service 123 may generate a delta difference between the third and fourth versions of package 223A (delta V3, V4), and commit the delta V3, V4 to the Git repository 225. In this way, the delta difference generation service 123 may create a volume of discreet repositories that includes the delta difference history between each of the existing versions of the package 223A.

The package manager 224 may receive a request from the client to update the package 223A to a particular subsequent version of the package 223A and may retrieve from the Git repository 225, the delta difference corresponding to the particular subsequent version of the package 223A and the delta difference corresponding to each subsequent version of the package 223A before the particular subsequent version of the package (that the client wishes to update to). This is illustrated in the example of FIG. 2B, where in response to receiving a request from a user running package 223A V2 to update to package 223A V4, the package manager 224 may access the delta V2, V3 (delta difference corresponding to 223A V3 which is a subsequent version of the package 223A before the particular subsequent version of the package—which is 223A V4) and the delta V3, V4 (delta difference corresponding to the particular subsequent version of the package 223A) and build package 223A V4 based on package 223A V2 and the delta V2, V3 and the delta V3, V4. The package manager 224 may build package 223A V4 by adding changes captured by the delta V2, V3 and the delta V3, V4 to the package 223A V2. Similarly, in response to receiving a request from a user running package 223A V1 to update to package 223A V4, the package manager 224 may access the delta V1, V2, the delta V2, V3 and the delta V3, V4 and build package 223A V4 based on package 223A V2 and the delta V1, V2, the delta V2, V3 and the delta V3, V4. In this way, the package manager 224 can build any version of a package and can also create variants of certain packages that suits particular needs.

In some embodiments, the package manager 224 can revert from a newer version of a package to a previous version of the package using the delta differences committed to the Git repository 225. Stated differently, in response to receiving a request to revert from the current version of the package 223A to a particular previous version among a plurality of previous versions of the package 223A, the package manager 224 may retrieve from the Git repository 225, a delta difference corresponding to the current version of the package 223A and a delta difference for each previous version after the particular previous version of the package 223A to be reverted to.

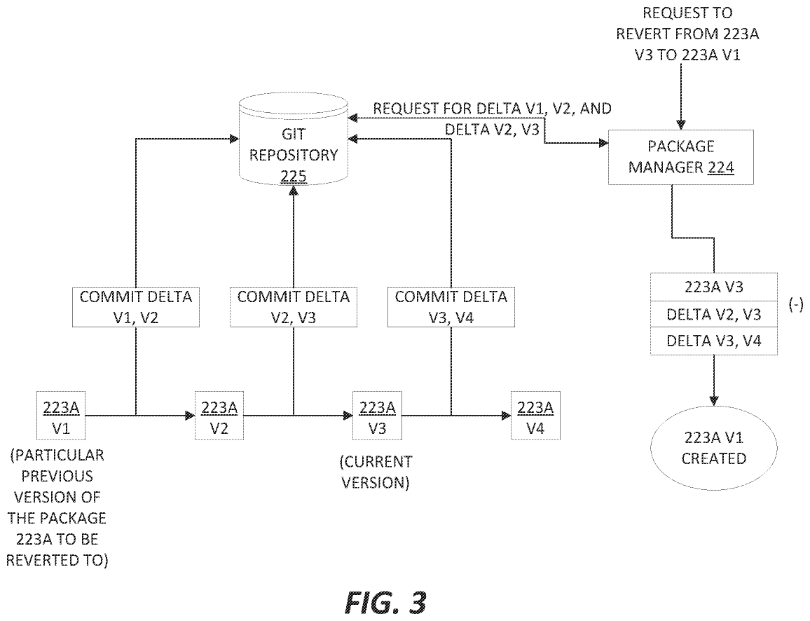

This is illustrated in the example of FIG. 3, where in response to receiving a request from a user running package 223A V3 to revert to package 223A V1, the package manager 224 may access the delta V2, V3 and the delta V1, V2 and build package 223A V1 based on package 223A V3 and the delta V1, V2 and the delta V2, V3 e.g., by removing/subtracting changes captured by the delta V1, V2 and the delta V2, V3 from the package 223A V3.

It should be noted that embodiments of the present disclosure may generate a slightly higher computational footprint as multiple delta differences are being stored instead of creating a single delta difference as is done by current systems. This may be particularly the case in scenarios where changes made between version 1 and version 2 of a package have been removed between version 2 and version 3, resulting in a smaller difference between version 1 and version 3. However, because current delta difference systems only operate between a particular version of a package and an immediately subsequent version of the particular package (e.g., version n and version n+1), a user who is running version n of a package, has missed version n+1, and wishes to update to version n+2 of the package, must download a full copy of version n+2 instead of merely a delta difference between version n+1 and version n+2. In addition, the increased computation footprint allows for situations where a user deliberately does not want to, or cannot currently upgrade to a newer version (e.g., for stability and/or access reasons), and enables users to deploy a strategy of targeted upgrades without paying the costs associated with downloading full versions of packages. This is important in e.g. network constraint scenarios.

In some embodiments, the package manager 224 may use a debugging tool such as Git bisect in conjunction with the techniques described above in order to identify a version of a package where an error/bug was introduced. Git bisect is a tool that uses a binary search algorithm to analyze a project's commit history and identify a commit where a bug was introduced. Git bisect may receive an identification of a bad commit (i.e., corresponding to a version that is known to contain the bug), and an identification of a commit before the bug was introduced that is known to be good (i.e., corresponding to a version that is known to not contain the bug). Git bisect may then select a commit that is somewhere between those two endpoints (the bad commit and the good commit) and inquire whether the selected commit is good or bad. Git bisect may continue narrowing down the range in this fashion until it finds the exact commit where the bug was introduced.

For each commit that Git bisect selects when narrowing down the range, the package manager 224 may rebuild the corresponding version of the package using the appropriate delta differences, as described hereinabove. Using the example of FIG. 2B, in response to determining that package 223A V4 has a bug, the package manager 224 (executing the Git bisect functionality) may select the commit corresponding to delta V3, V4 as the starting point when identifying where the bug was introduced. The package manager 224 may access the delta V3, V4 and build package 223A V3 by removing changes captured by the delta V3, V4 from the package 223A V4. Upon receiving an indication that package 223A V3 also has the bug, the package manager 224 (executing the Git bisect functionality) may then select the commit corresponding to delta V2, V3 as the next commit to analyze. The package manager 224 may access the delta V2, V3 and the delta V3, V4 and build package 223A V2 by removing changes captured by the delta V2, V3 and the delta V3, V4 from the package 223A V4. The package manager 224 may receive an indication that package 223A V2 is good, and thus determine that package 223A V3 is where the bug was introduced. It should be noted that Git bisect can be used to find a particular commit that changed any property of a project (not just one where a bug was introduced) e.g., the commit that fixed a bug, or the commit that caused a benchmark's performance to improve. Thus, embodiments of the present disclosure can use a debugging tool such as Git bisect in conjunction with the techniques described above in order to identify a particular commit that changed any property of a project.

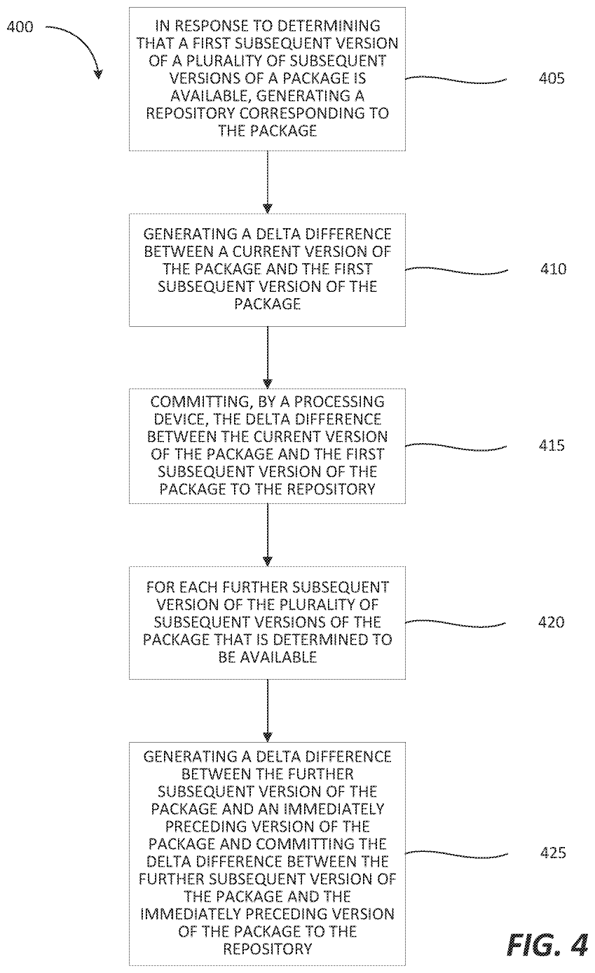

FIG. 4 is a flow diagram of a method 400 for building new versions of a package based by generating a repository (e.g., a Git repository) in which a delta difference generated between a new version of the package and a version of the package immediately preceding the new version of the package can be committed each time a new version is released. In this way, a volume of discreet repositories that includes the delta difference history between each of the existing versions of the package is maintained and can be accessed to enable a client to build a subsequent (or previous) version of a package even if the current version they are running is multiple versions behind (or ahead). Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 120 illustrated in FIGS. 2A-2B).

Referring simultaneously to FIGS. 2A and 2B, the host OS 221 may include a first version of package 223A (illustrated in FIGS. 2A and 2B as 223A V1) that is the current version of package 223A and the package manager 224 may continuously monitor for new versions (also sometimes referred to herein as subsequent versions) of package 223A. At block 405, in response to detecting that a second version (also sometimes referred to herein as a first subsequent version) of package 223A (223A V2 in FIGS. 2A and 2B) has been released, the delta difference generation service 123 may create the Git repository 225 which is dedicated to the package 223A. At block 410, the delta difference generation service 123 may generate a delta difference between the first and second versions of package 223A (i.e., the delta difference between 223A V1 and 223A V2—also referred to as delta V1, V2), and at block 415, may commit the delta V1, V2 to the Git repository 225. At block 420, upon determining that a third version (which may be one of a number of further subsequent versions) of package 223A (223A V3) has been released, the delta difference generation service 123 may at block 425 generate a delta difference between the second and third versions of package 223A (delta V2, V3), and commit the delta V2, V3 to the Git repository 225. The delta difference generation service 123 may generate and commit delta differences in this manner for each further subsequent version of the package that is released. For example, upon determining that a fourth version (which may be another one of the number of further subsequent versions) of package 223A (223A V4 in FIGS. 2A and 2B) has been released, the delta difference generation service 123 may generate a delta difference between the third and fourth versions of package 223A (delta V3, V4), and commit the delta V3, V4 to the Git repository 225. In this way, the delta difference generation service 123 may create a volume of discreet repositories that includes the delta difference history between each of the existing versions of the package 223A.

The package manager 224 may receive a request to update the package 223A to a particular subsequent version of the package 223A and may retrieve from the Git repository 225, the delta difference corresponding to the particular subsequent version of the package 223A and the delta difference corresponding to each subsequent version of the package 223A before the particular subsequent version of the package. This is illustrated in the example of FIG. 2B, where in response to receiving a request from a user running package 223A V2 to update to package 223A V4, the package manager 224 may access the delta V2, V3 and the delta V3, V4 and build package 223A V4 based on package 223A V2 and the delta V2, V3 and the delta V3, V4 e.g., by adding changes captured by the delta V2, V3 and the delta V3, V4 to the package 223A V2. Similarly, in response to receiving a request from a user running package 223A V1 to update to package 223A V4, the package manager 224 may access the delta V1, V2, the delta V2, V3 and the delta V3, V4 and build package 223A V4 based on package 223A V2 and the delta V1, V2, the delta V2, V3 and the delta V3, V4. In this way, the package manager 224 can build any version of a package and can also create variants of certain packages that suits particular needs.

In some embodiments, the package manager 224 can revert from a newer version of a package to a previous version of the package using the delta differences committed to the Git repository 225. Stated differently, in response to receiving a request to revert from the current version of the package 223A to a particular previous version among a plurality of previous versions of the package 223A, the package manager 224 may retrieve from the Git repository 225, a delta difference corresponding to the current version of the package 223A and a delta difference for each previous version after the particular previous version of the package 223A to be reverted to.

This is illustrated in the example of FIG. 3, where in response to receiving a request from a user running package 223A V3 to revert to package 223A V1, the package manager 224 may access the delta V2, V3 and the delta V1, V2 and build package 223A V1 based on package 223A V3 and the delta V1, V2 and the delta V2, V3 e.g., by removing/subtracting changes captured by the delta V1, V2 and the delta V2, V3 from the package 223A V3.

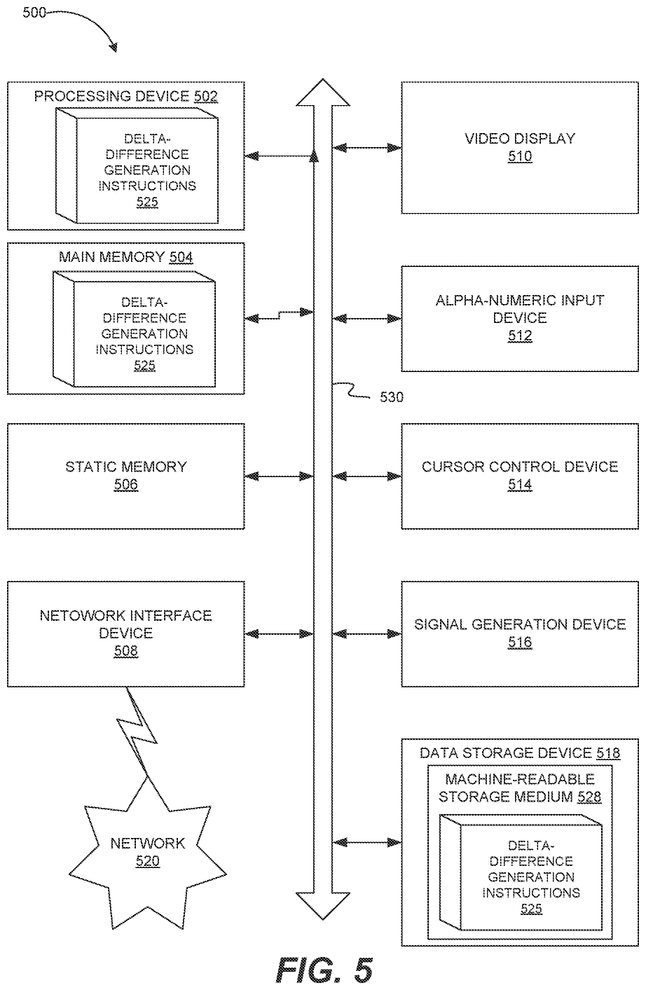

FIG. 5 illustrates a diagrammatic representation of a machine in the example form of a computer system 500 within which a set of instructions, for causing the machine to perform any one or more of the methodologies discussed herein for generating delta-differences for packages.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute delta-difference generation instructions 525, for performing the operations and steps discussed herein.

The data storage device 518 may include a machine-readable storage medium 528, on which is stored one or more sets of delta-difference generation instructions 525 (e.g., software) embodying any one or more of the methodologies of functions described herein. The delta-difference generation instructions 525 may also reside, completely or at least partially, within the main memory 504 or within the processing device 502 during execution thereof by the computer system 500; the main memory 504 and the processing device 502 also constituting machine-readable storage media. The delta-difference generation instructions 525 may further be transmitted or received over a network 520 via the network interface device 508.

The machine-readable storage medium 528 may also be used to store instructions to perform a method for object analysis/validation event publishing, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A method comprising:
in response to determining that a first subsequent version of a plurality of subsequent versions of a package is available, generating a repository corresponding to the package;
generating a delta difference between a current version of the package and the first subsequent version of the package;
committing, by a processing device, the delta difference between the current version of the package and the first subsequent version of the package to the repository; and
for each further subsequent version of the plurality of subsequent versions of the package that is determined to be available:
generating a delta difference between the further subsequent version of the package and an immediately preceding version of the package; and
committing the delta difference between the further subsequent version of the package and the immediately preceding version of the package to the repository.

2. The method of claim 1, further comprising:
in response to receiving a request to update the package to a particular subsequent version of the package, retrieving from the repository, a delta difference corresponding to the particular subsequent version of the package and a delta difference corresponding to each subsequent version of the package before the particular subsequent version of the package; and
building the particular subsequent version of the package based on the current version of the package and each of the retrieved delta differences.

3. The method of claim 2, wherein building the particular subsequent version of the package comprises:
adding changes indicated by each of the retrieved delta differences to the current version of the package.

4. The method of claim 1, further comprising:
in response to receiving a request to revert to a particular previous version among a plurality of previous versions of the package, retrieving from the repository, a delta difference corresponding to the current version of the package and each previous version after the particular previous version of the package; and
building the particular previous version of the package based on the current version of the package and the retrieved delta differences.

5. The method of claim 4, wherein building the particular previous version of the package comprises:
subtracting changes indicated by each of the retrieved delta differences from the current version of the package.

6. The method of claim 1, further comprising:
using a debugging tool to select one or more particular previous versions of the package to analyze to determine a previous version where a change was introduced; and
for each of the one or more particular previous versions of the package:
retrieving from the repository, a delta difference corresponding to the current version of the package and each previous version after the particular previous version of the package; and
building the particular previous version of the package based on the current version of the package and each of the retrieved delta differences.

7. The method of claim 1, wherein the repository is a Git repository.

8. A system comprising:
a memory; and
a processing device, operatively coupled to the memory, the processing device to:
in response to determining that a first subsequent version of a plurality of subsequent versions of a package is available, generate a repository corresponding to the package;
generate a delta difference between a current version of the package and the first subsequent version of the package;
commit the delta difference between the current version of the package and the first subsequent version of the package to the repository; and
for each further subsequent version of the plurality of subsequent versions of the package that is determined to be available:
generate a delta difference between the further subsequent version of the package and an immediately preceding version of the package; and
commit the delta difference between the further subsequent version of the package and the immediately preceding version of the package to the repository.

9. The system of claim 8, wherein the processing device is further to:
in response to receiving a request to update the package to a particular subsequent version of the package, retrieve from the repository, a delta difference corresponding to the particular subsequent version of the package and a delta difference corresponding to each subsequent version of the package before the particular subsequent version of the package; and
build the particular subsequent version of the package based on the current version of the package and each of the retrieved delta differences.

10. The system of claim 9, wherein to build the particular subsequent version of the package, the processing device is to:
add changes indicated by each of the retrieved delta differences to the current version of the package.

11. The system of claim 8, wherein the processing device is further to:
in response to receiving a request to revert to a particular previous version among a plurality of previous versions of the package, retrieve from the repository, a delta difference corresponding to the current version of the package and each previous version after the particular previous version of the package; and
build the particular previous version of the package based on the current version of the package and the retrieved delta differences.

12. The system of claim 11, wherein to build the particular previous version of the package, the processing device is to:
subtract changes indicated by each of the retrieved delta differences from the current version of the package.

13. The system of claim 8, wherein the processing device is further to:
use a debugging tool to select one or more particular previous versions of the package to analyze to determine a previous version where a change was introduced; and
for each of the one or more particular previous versions of the package:
retrieve from the repository, a delta difference corresponding to the current version of the package and each previous version after the particular previous version of the package; and
build the particular previous version of the package based on the current version of the package and each of the retrieved delta differences.

14. The system of claim 8, wherein the repository is a Git repository.

15. A non-transitory computer-readable medium having instructions stored thereon which, when executed by a processing device, cause the processing device to:
in response to determining that a first subsequent version of a plurality of subsequent versions of a package is available, generate a repository corresponding to the package;
generate a delta difference between a current version of the package and the first subsequent version of the package;
commit, by the processing device, the delta difference between the current version of the package and the first subsequent version of the package to the repository; and
for each further subsequent version of the plurality of subsequent versions of the package that is determined to be available:
generate a delta difference between the further subsequent version of the package and an immediately preceding version of the package; and
commit the delta difference between the further subsequent version of the package and the immediately preceding version of the package to the repository.

16. The non-transitory computer-readable medium of claim 15, wherein the processing device is further to:
in response to receiving a request to update the package to a particular subsequent version of the package, retrieve from the repository, a delta difference corresponding to the particular subsequent version of the package and a delta difference corresponding to each subsequent version of the package before the particular subsequent version of the package; and
build the particular subsequent version of the package based on the current version of the package and each of the retrieved delta differences.

17. The non-transitory computer-readable medium of claim 16, wherein to build the particular subsequent version of the package, the processing device is to:
add changes indicated by each of the retrieved delta differences to the current version of the package.

18. The non-transitory computer-readable medium of claim 15, wherein the processing device is further to:
in response to receiving a request to revert to a particular previous version among a plurality of previous versions of the package, retrieve from the repository, a delta difference corresponding to the current version of the package and each previous version after the particular previous version of the package; and
build the particular previous version of the package based on the current version of the package and the retrieved delta differences.

19. The non-transitory computer-readable medium of claim 18, wherein to build the particular previous version of the package, the processing device is to:
subtract changes indicated by each of the retrieved delta differences from the current version of the package.

20. The non-transitory computer-readable medium of claim 15, wherein the processing device is further to:
use a debugging tool to select one or more particular previous versions of the package to analyze to determine a previous version where a change was introduced; and
for each of the one or more particular previous versions of the package:
retrieve from the repository, a delta difference corresponding to the current version of the package and each previous version after the particular previous version of the package; and
build the particular previous version of the package based on the current version of the package and each of the retrieved delta differences.
